(19) United States
(12) Patent Application Publication
(10) Pub. No.: US 2004/0144226 A1
(43) Pub. Date: Jul. 29, 2004

(54) Material cutting apparatus

(76) Inventor: Phillip Edmund West, Gretna, VA (US)

Correspondence Address: HARNESS, DICKEY & PIERCE, P.L.C., P.O. BOX 828, BLOOMFIELD HILLS, MI, 48303, US

(21) Appl. No.: 10/350,664

(22) Filed: Jan. 24, 2003

(51) Int. Cl. B26D 5/00; B26D 7/00; B26D 1/22; B23D 19/04

(52) U.S. Cl. 83/62; 83/505; 83/167

(57) ABSTRACT

A cutting apparatus for cutting a material, such as leather, having a drum, a plurality of rollers, a cutter and a pair of belts. The drum includes a drum surfaces and rotates about an axis. The cutter has a cutting edge that is in contact with the drum surface and is oriented generally perpendicular to the axis. The rollers are arranged generally parallel to the axis and support the belts for rotation thereon. Each of the belts is disposed on an opposite side of the cutting edge and is positioned such that a portion of each belt extends about a corresponding portion of the drum surface forward of the cutting edge. The portion of the belts and the portion of the drum surface are positioned to frictionally co-engage the material and drive the material into contact with the cutting edge.

### FIELD OF THE INVENTION

The present invention relates to a material cutting apparatus, and more particularly to a cutting apparatus for cutting a material, such as leather, into strips.

### BACKGROUND OF THE INVENTION

Leather covered products are very common within the furniture industry and include articles such as chairs, pillows, cushions, seat covers and couches. During construction and assembly, each of these items of furniture utilize multiple, separate pieces of leather material that are sized and joined together through an appropriate process, such as sewing. For example, a typical leather chair requires a back piece, a pair of side pieces, a seat piece, and a seat back piece, as well as other miscellaneous pieces, each of which having a specific shape and size.

To accurately create these leather pieces from a leather hide, which is generally about 8 feet long by 8 feet wide in size, a Computer Numerical Control machine (CNC machine) is typically employed. The CNC machine employs single knife to cut the hide in a predetermined shape that is based on information entered into a controller or computer. These shaped pieces typically use approximately 65%-70% of the leather hide and the remaining 30%-35% that is leftover (e.g., the portions of the hide between the parts and/or the border of the hide) constitute leather scrap. This leather scrap is often times too small to be used in the CNC machine and as such, leather scrap is typically thrown away.

Presently, CNC machines are also commonly employed to produce leather strips that are used for welting. Welting is a decorative border or filler that is used where two pieces of leather meet or where the leather abuts the frame of the furniture article. One common welting utilizes an approximately 1½ inch wide strip of leather with a small cord that is sewn into the length of the leather strip. Due to the length and narrow width of the leather strips, their fabrication by CNC machines is relatively time consuming. As such, the use of CNC machines for producing welting strips tends to lower the output of relatively high-value shaped leather pieces (e.g., the back piece, side pieces, seat piece and seat back piece of the typical leather chair) from the CNC machines.

Accordingly, there remains a need in the art for an improved device and method for fabricating welting in a more cost-effective manner.

### SUMMARY OF THE INVENTION

A cutting apparatus for cutting a material, such as leather. The cutting apparatus includes a drum, a plurality of rollers, round knives and a set of belts. The drum includes a drum surface and rotates about an axis. The knives have a cutting edge that is in contact with the drum surface and is oriented generally perpendicular to the axis. The rollers are arranged generally parallel the axis and support the belts for rotation thereon. Each of the belts is disposed on an opposite side of the cutting edge and is positioned such that a portion of each belt extends about a corresponding portion of the drum surface forward of the cutting edge. The portion of the belts and the portion of the drum surface are positioned to frictionally co-engage the material and drive the material into contact with the cutting edge to thereby permit the cutting edge to form a cut in the material.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side elevation view of a material cutting apparatus constructed in accordance with the teachings of the present invention;

FIG. 2 is a top plan view of the material cutting apparatus of FIG. 1;

FIG. 3 is a sectional view taken along line 3-3 of FIG. 2;

FIG. 4 is an enlarged view of a portion of the material cutting apparatus of FIG. 1 showing the feeder and cutter assemblies in greater detail;

FIG. 5 is an exploded perspective view of a portion of the material cutting apparatus of FIG. 1 illustrating the feeder and cutter assemblies in a disassembled state; and

FIG. 6 is side view of a second material cutting apparatus constructed in accordance with the teachings of the present invention.

### DETAILED DESCRIPTION OF THE PREFERRED EMBODIMENTS

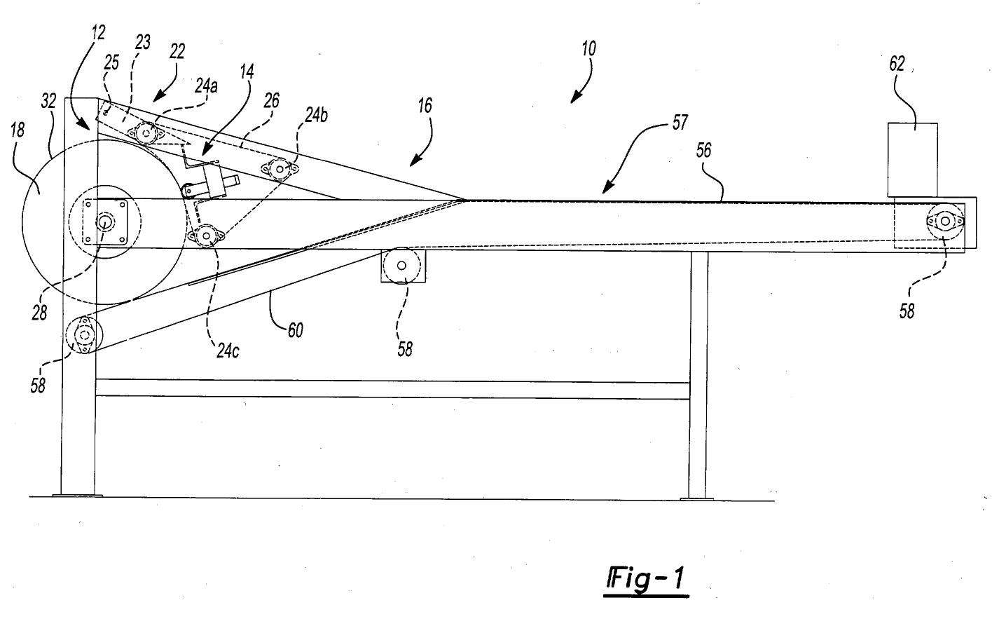

Referring generally to FIG. 1, a material cutting apparatus constructed in accordance with the teachings of the present invention is generally indicated by reference numeral 10. In the particular embodiment provided, the material cutting apparatus 10 is shown to include a feeder assembly 12, a cutter assembly 14 and a frame 16.

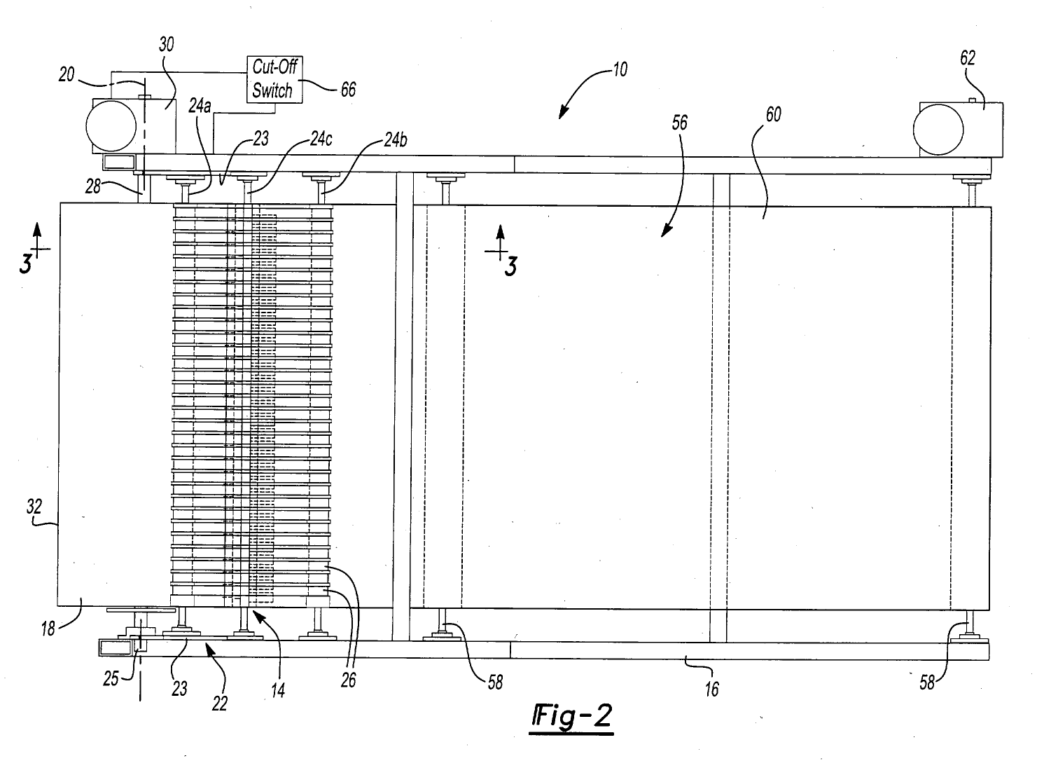

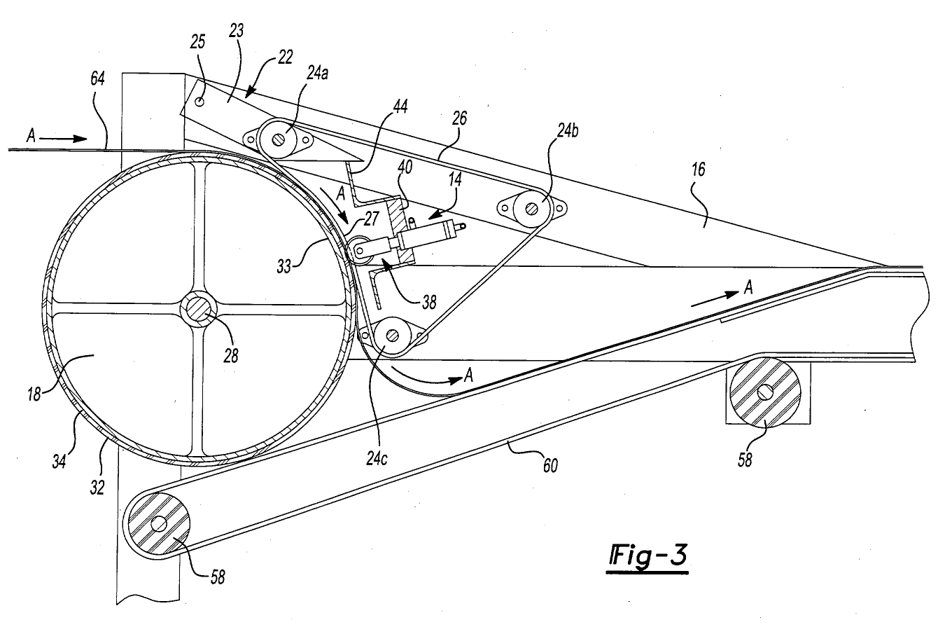

The feeder assembly 12 includes a drum 18, a swing mount 22, a plurality of rollers 24 (i.e., rollers 24a, 24b, and 24c) and a plurality of belts 26. A pin 28, which is coupled to the frame 16, supports the drum 18 for rotation about an axis 20. In the particular example provided, the drum 18 is coupled for rotation with the pin 28 and the pin 28 is rotated by a motor 30 (FIG. 2) that is mounted to the frame 16. The drum 18 includes an outer drum surface 32, which is preferably formed from a resilient material 34 (FIG. 3), such as rubber having a durometer of about 85 to about 100. The resilient material 34 allows the drum surface 32 to somewhat yield to the cutter assembly 14, as will be described in greater detail below.

With reference to FIGS. 1 and 3, the swing mount 22 is illustrated to include a pair of swing plates 23 and a pair of pivot pins 25. Each pivot pin 25 is employed to pivotably couple a first end of an associated swing plate 23 to an opposite side of the frame 16.

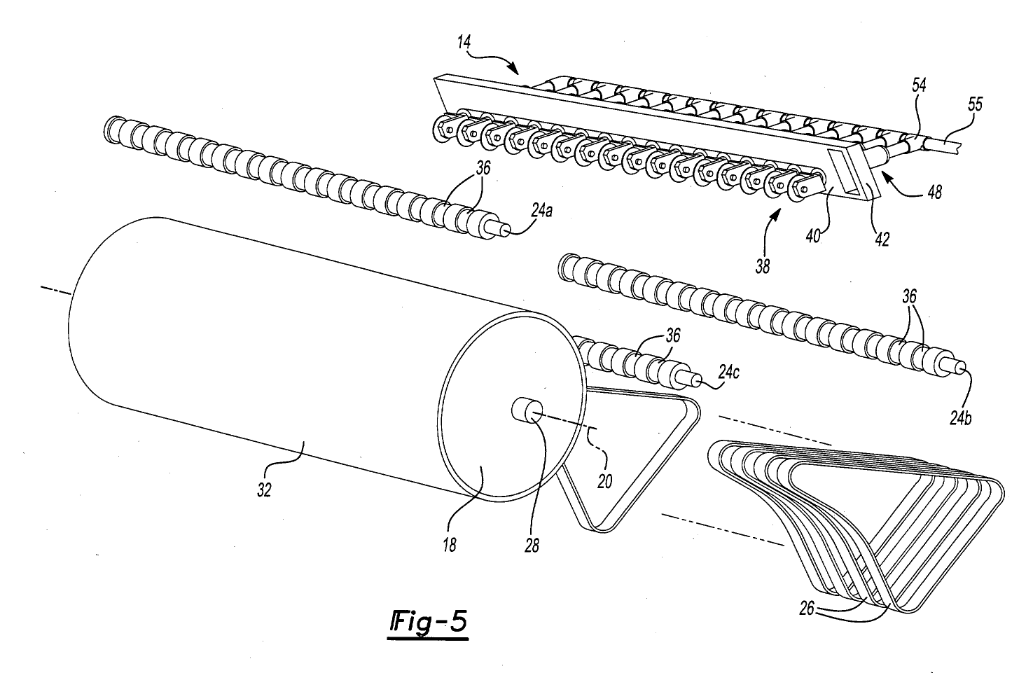

With brief reference to FIG. 5, the rollers 24 are illustrated to optionally include a plurality of laterally spaced-apart grooves 36. The width of each groove 36 is sized to receive an associated one of the belts 26 therein. Although the grooves 36 of the example provided are illustrated as being equally sized and spaced apart, those skilled in the art will readily appreciate that the rollers 24 may be configured with two or more different spacings if the material cutting apparatus 10 is to be configured to fabricate material strips of different widths. Those skilled in the art will also appreciate that although the rollers 24 are illustrated as being unitarily formed, other construction techniques may also be employed. For example, removable collars (not shown) may be secured to the rollers at desired locations to thereby form the grooves of a desired width (between adjacent collars).

With reference to FIGS. 2 and 3, a first portion of the rollers 24, which consists of the roller 24a in the example provided, is mounted to the swing plates 23 at a location opposite the pivot pins 25. Accordingly, the first portion of the rollers 24 (e.g., roller 24a) is supported for rotation by the swing mount 22 and pivotably coupled to the frame 16 via the swing mount 22. A remaining portion of the rollers 24 (e.g., rollers 24b and 24c in the example provided) are supported by the frame 16 for rotation. Each of the rollers 24 is mounted in a manner that is parallel to the drum 18. In the embodiment illustrated, the rollers 24 are disposed in side view in a roughly triangular pattern such that a portion of the drum 18 extends between rollers 24a and 24c.

Each of the belts 26 is disposed around the rollers 24 in a respective groove 36. As the swing mount 22 is pivotably coupled to the frame 16, the weight of the swing mount 22 and the roller 24a cooperate to bias the roller 24a toward the drum surface 32. In the example provided, the pivoting of the roller 24a toward the drum surface 32 presses a portion 27 of the belts 26 into contact (i.e., frictional engagement) with a portion 33 of the drum surface 32 such that rotation of the drum 18 causes corresponding rotation of the belts 26.

With reference to FIGS. 3 and 5, the cutter assembly 14 of the example provided is illustrated to include a plurality of cutters 38 that are mounted to a cutter bar 40. The cutter bar 40 is mounted to the frame 16 offset from the drum 18 and between the rollers 24a and 24b. The cutter bar 40 has a handle 42 (FIG. 5) and is mounted between a pair of mounting flanges 44 that form a portion of the frame 16. A plurality of rollers (not shown), such as skate wheels, are employed to secure the cutter bar 40 to the mounting flanges 44 for easy removal. In the example provided, the cutter bar 40 is formed from a light-weight structural material, such as aluminum bar stock, so that the cutter assembly 14 may be more easily removed from the frame 16 for purposes that may include, for example, maintaining the cutters 38 and/or adjusting the location of the cutters 38.

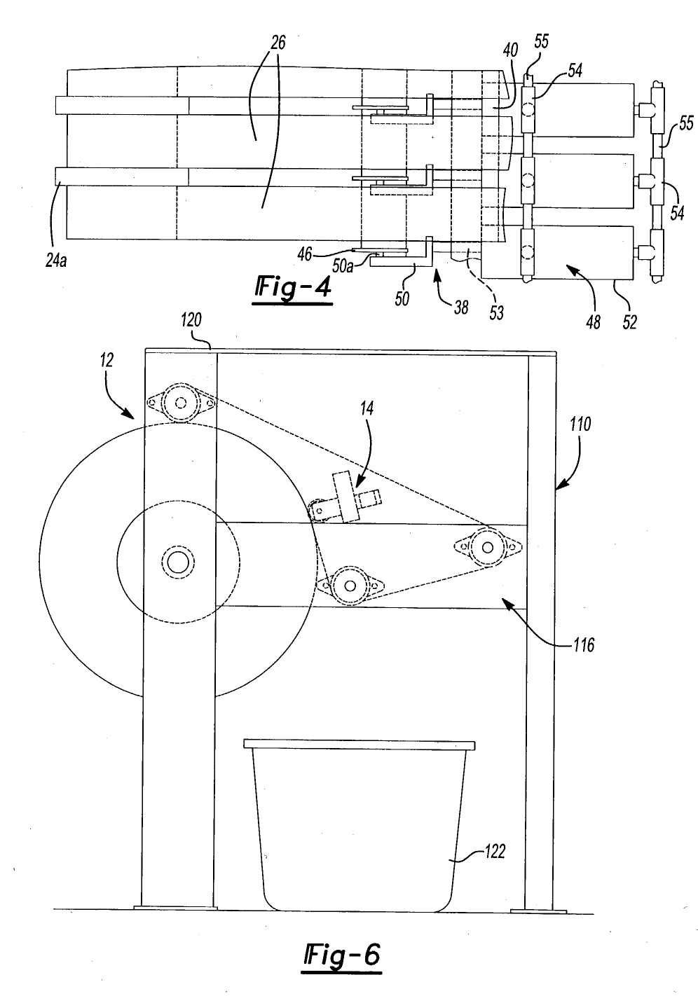

As best seen in FIGS. 3 and 4, each of the cutters 38 includes a cutting edge 46 that is configured to make a cut in a direction that is generally perpendicular to the axis 20 of the drum 18. In the particular example illustrated, the cutters 38 are disk-shaped and the cutting edge 46 lies about its outer circumference. Those skilled in the art will appreciate, however, that the cutters 38 may be differently configured (e.g., a flat knife blade with a straight or arcuately shaped blade) and that the cutting edge 46 may be either straight or serrated.

In the example provided, each of the cutters 38 is coupled to a mounting cylinder 48 via a bracket 50 and a bracket pin 50a. The cylinder 48 is a fluid cylinder, such as a double-acting pneumatic cylinder, which is fixedly but removably coupled to the cutter bar 40 in a known manner, such as bolts or a threaded connection. The cylinder 48 includes a cylinder housing 52 and a rod 53 that extends from a single side of the cylinder housing 52. The rod 53 has a generally square cross-section and extends through a generally square slot (not shown) formed in the cylinder housing 52 to prevent rotation of the rod 53. The bracket 50 is attached to the rod 53 in a known manner so that movement of the rod 53 will affect the position of the cutter 38 that is attached to the bracket 50.

As the mounting cylinders 48 are double-acting, fittings 54 and tubing 55 are employed to couple each side of the mounting cylinders 48 to a source of fluid pressure, such as an air compressor (not shown). In the example illustrated, the mounting cylinders 48 are coupled in series to a source of fluid pressure. Those skilled in the art will appreciate, however, that depending on various factors, such as the type and thickness of the material that is to be cut, pressure regulators (not shown) may need to be employed between each mounting cylinder 48 and the source of fluid pressure so that the pressure of the fluid provided to each mounting cylinder is consistent.

As those skilled in the art will appreciate, single-acting cylinders may be used in place of the double-acting cylinders to eliminate one of the fluid connections (i.e., one set of fittings 54 and tubing 55). When single-acting cylinders are employed, a spring biases the rod 53 (and the cutter 38) out of engagement with the drum 18; fluid pressure is employed to overcome the force of the spring to engage the cutter 38 against the drum surface 32.

The frame 16 includes an optional collection assembly 57, which comprises a collection bed 56, rollers 58 rotatably supported by the frame 16, and a collection belt 60 disposed on the rollers 58. The collection bed 56 extends away from the feeding assembly 12 and the cutter assembly 14. The collection belt 60 runs along the collection bed 56 and terminates at its forward end at a location underneath the drum 18. A motor 62 drives one of the rollers 58 which in turn drives the collection belt 60.

Referring to FIG. 3, material 64 is fed into the feeder assembly 12 between the drum 18 and the plurality of belts 26, as indicated by the arrow A. The material 64 is frictionally grabbed by the rotating drum 18 and the plurality of belts 26 which draws the material 64 toward the cutter assembly 14. The application of fluid pressure to the mounting cylinders 48 forces the rod 53 outwardly toward the drum 18 so that the cutting edges 46 are then forced against the drum surface 32. In the embodiment provided, approximately 5 to 10 pounds of air pressure is employed and the piston 50 of the mounting cylinders 52 have an area of about 0.887 square inches, thereby providing a force of about 5 to 9 pounds on each cutter 38, which is sufficient to cut leather material having a thickness of about 1/8 inch as it is drawn through the cutters 38. The plurality of belts 26 serve to force the material 64 flat against the drum 18 as it passes the cutter assembly 14. The cut material 64 falls onto the collection belt 60, which transports the cut material 64 to the collection bed 56 where the cut material 64 can be easily collected.

As the mounting cylinders 48 are exposed to relatively constant fluid pressure, the mounting cylinders 48 are able to compensate for irregularities in the thickness of the material 64 or the drum surface 32 through the retraction or extension rod 53 to thereby avoid damaging the drum 18.

If the material 64 has a thickness greater than a predetermined amount, for example 1/8 inch, the roller 24a is pushed upwards away from the drum 18 (since the roller 24a is mounted to the swing mount 22, which pivots relative to the frame 16 about the pivot pin 25) by a predetermined amount where the swing mount 22 cooperates with a cut-off switch 66 to disable rotation of the drum 18. Those skilled in the art will appreciate that the cut-off switch 66 may be employed to disengage a clutch assembly (between the motor 30 and the pin 28) or to generate an electrical signal that is employed through various electronic controls (e.g., relays) to disconnect the motor 30 from a source of electrical power.

Referring now to FIG. 6, an alternative material cutting apparatus 110 is shown having the feeder assembly 12 and the cutter assembly 14 mounted on a frame 116. The feeder assembly 12, cutter assembly 14, and the frame 116 are supported by a base 118. The frame 116 includes a safety cover 120 disposed over the plurality of belts 26 of the feeder assembly 12 and over the cutter assembly 14. The safety cover 120 is preferably made of a transparent plastic material that allows the feeder assembly 12 and cutter assembly 14 to be visible during operation while simultaneously protecting the feeder assembly 12 and cutter assembly 14 from being fouled by foreign objects. Once material has been fed into the material cutting apparatus 110, the cut material is collected in a receptacle 122, which may then be easily transported for further processing.

While the invention has been described in the specification and illustrated in the drawings with reference to various embodiments, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. A cutting apparatus for cutting a material, the cutting apparatus comprising:
a drum having a drum surface, the drum rotating about an axis;
a plurality of rollers arranged generally parallel the axis;
a cutter having a cutting edge that is in contact with the drum surface and generally perpendicular to the axis; and
a pair of belts mounted to the rollers, each of the belts being disposed on an opposite side of the cutting edge, a portion of each of the belts extending about a corresponding portion of the drum surface forward of the cutting edge;
wherein the portion of the belts and the portion of the drum surface are positioned to frictionally co-engage the material and drive the material into contact with the cutting edge to thereby permit the cutting edge to form a cut in the material.

2. The cutting apparatus of claim 1, wherein the cutter is disk-shaped and the cutting edge is formed about its outer perimeter.

3. The cutting apparatus of claim 2, further comprising a mounting cylinder having a first portion and a second portion, the first portion being fixed relative to the drum, the second portion being movable relative to the first portion in a direction that is generally perpendicular to the axis, the cutter being rotatably mounted to an end of the second portion.

4. The cutting apparatus of claim 3, wherein the air cylinder provides approximately 8 pounds of force to the bladed disk.

5. The cutting apparatus of claim 1, wherein the drum surface is comprised of a resilient material.

6. The cutting apparatus of claim 1, further comprising a frame and a swing mount, the frame supporting the drum and a first portion of the rollers, the swing mount being pivotably coupled to the frame and supporting a second portion of the rollers.

7. The cutting apparatus of claim 1, further comprising cut-off switch that is operable in a first condition, which does not inhibit rotation of the drum, and a second condition, which inhibits rotation of the drum, wherein the cut-off switch changes from the first condition to the second condition in response to rotation of the swing mount beyond a predetermined point and wherein movement of the swing mount to the predetermined point occurs when the material that is fed between the belts and the drum surface has a thickness that exceeds a predetermined thickness.

8. The cutting apparatus of claim 7, wherein the predetermined thickness is about 1/8 inch.

9. The cutting apparatus of claim 1, further comprising a receptacle for collecting the material after it is cut by the cutter.

10. The cutting apparatus of claim 1, further comprising a collection device that is configured to receive and transport the cut material to a predetermined location.

11. The cutting apparatus of claim 10, wherein the collection device includes a rotating belt and wherein a portion of the rotating belt is positioned under the drum.

12. A cutting apparatus for cutting a sheet material into material strips of a predetermined width, the cutting apparatus comprising:
a drum having a drum surface;
a frame supporting the drum for rotation about an axis;
a cutter bar mounted to the frame;
a plurality of cutters associated with the cutter bar, each of the cutters having a cutting edge that is oriented generally perpendicular to the axis, each of the cutting edges being spaced apart by a distance that is equal to the predetermined width of the material strips;
a plurality of rollers arranged generally parallel the axis; and
a plurality of belts mounted on the rollers and arranged such that one of the cutters is disposed between a pair of the belts, a portion of each of the belts extending about a corresponding portion of the drum surface forward of the cutting edges of the cutters;
wherein the portion of the belts and the portion of the drum surface are positioned to frictionally co-engage the material and drive the material into contact with the cutting edge to thereby permit the cutting edges to form the material strips.

13. The cutting apparatus of claim 12, wherein each of the cutters is disk-shaped with its cutting edge being formed about its outer perimeter.

14. The cutting apparatus of claim 13, further comprising a plurality of mounting cylinders, each mounting cylinder having a first portion and a second portion, the first portion being coupled to the cutter bar, the second portion being movable relative to the first portion in a direction that is generally perpendicular to the axis, the cutter being rotatably mounted to an end of the second portion.

15. The cutting apparatus of claim 14, wherein the air cylinders provide approximately 8 pounds of force to the bladed disks.

16. The cutting apparatus of claim 12, wherein the drum surface is comprised of a resilient material.

17. The cutting apparatus of claim 12, wherein each of the rollers includes a plurality of grooves, each of the grooves being configured to receive an associated one of the plurality of belts, the grooves being configured to maintain the belts in a spaced-apart condition.

18. The cutting apparatus of claim 12, wherein the cutter bar is removably coupled to the frame.

19. The cutting apparatus of claim 12, further comprising a swing mount and a pivot pin, the pivot pin pivotably coupling the swing mount to the frame, the swing mount supporting a first portion of the rollers at an end opposite opposite the pivot pin, the frame supporting a remaining portion of the rollers.

20. The cutting apparatus of claim 19, further comprising cut-off switch that is operable in a first condition, which does not inhibit rotation of the drum, and a second condition, which inhibits rotation of the drum, wherein the cut-off switch changes from the first condition to the second condition in response to rotation of the swing mount beyond a predetermined point and wherein movement of the swing mount to the predetermined point occurs when the material that is fed between the belts and the drum surface has a thickness that exceeds a predetermined thickness.
